(19) United States
(12) Patent Application Publication
(10) Pub. No.: US 2024/0274996 A1
(43) Pub. Date: Aug. 15, 2024

(54) BATTERY DEVICE

(71) Applicant: HONDA MOTOR CO., LTD., Tokyo (JP)

(72) Inventors: Yuya Ishihara, Wako-shi (JP); Atsushi Okazaki, Wako-shi (JP); Wataru Ohira, Wako-shi (JP)

(21) Appl. No.: 18/436,300

(22) Filed: Feb. 8, 2024

(30) Foreign Application Priority Data
Feb. 15, 2023 (JP) 2023-021306

(51) Int. Cl. H01M 50/553; H01M 50/211; H01M 50/503; H01M 50/55

(52) U.S. Cl. CPC H01M 50/553; H01M 50/211; H01M 50/503; H01M 50/55

(57) ABSTRACT

A battery device includes a lead tab electrically connected to a positive electrode tab provided for a first battery cell among a plurality of battery cells and a negative electrode tab provided for a second battery cell adjacent to the first battery cell among the plurality of battery cells, and a lead tab electrically connected to a positive electrode tab provided for a third battery cell among the plurality of battery cells and a negative electrode tab provided for a fourth battery cell adjacent to the third battery cell among the plurality of battery cells, wherein the lead tabs are adjacent to each other in the Y direction.

### CROSS-REFERENCE TO RELATED APPLICATIONS

This application is based upon and claims the benefit of priority from Japanese Patent Application No. 2023-021306 filed on Feb. 15, 2023, the contents of which are incorporated herein by reference.

### BACKGROUND OF THE INVENTION

### Field of the Invention

The present invention relates to a battery device.

### Description of the Related Art

JP 2013-235828 A discloses a battery pack (battery device) including stacked battery cells.

### SUMMARY OF THE INVENTION

JP 2013-235828 A merely arranges wires in battery cells. Nowadays, better battery devices are required.

An object of the present invention is to solve the aforementioned problem.

An aspect of the present invention is a battery device including a plurality of battery cells stacked in a first direction; a first lead tab that is electrically connected to a first electrode tab provided for a first battery cell among the plurality of battery cells, and a second electrode tab provided for a second battery cell adjacent to the first battery cell among the plurality of battery cells, and is formed integrally with at least one of the first electrode tab or the second electrode tab; and a second lead tab that is electrically connected to a third electrode tab provided for a third battery cell among the plurality of battery cells, and a fourth electrode tab provided for a fourth battery cell adjacent to the third battery cell among the plurality of battery cells, and is formed integrally with at least one of the third electrode tab or the fourth electrode tab, wherein the first lead tab and the second lead tab are adjacent to each other in a second direction that intersects the first direction.

According to the present invention, a better battery device can be provided.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of a battery device;

FIG. 2 is a perspective view of a battery module;

FIG. 3 is a perspective view of a battery cell;

FIG. 4 is a perspective view showing a first battery cell;

FIG. 5 is a perspective view showing a second battery cell;

FIG. 6 is a perspective view showing a third battery cell;

FIG. 7 is a perspective view showing a fourth battery cell;

FIG. 8 is a perspective view of the battery module;

FIG. 9 is a perspective view showing a connection portion between a sub-board and a lead tab;

FIG. 10 is a cross-sectional view showing the connection portion between the sub-board and the lead tab.

### DETAILED DESCRIPTION OF THE INVENTION

### Embodiment

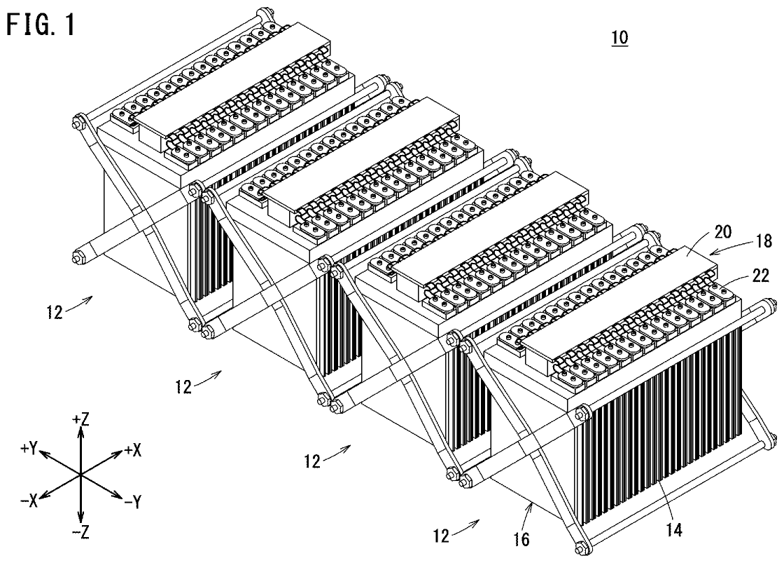

A battery device according to an embodiment is described with reference to the drawings. FIG. 1 is a perspective view of a battery device 10. In FIG. 1, arrows indicating the X, Y and Z directions are shown. The X, Y, and Z directions are perpendicular to each other. One of the X direction is defined as the +X direction and the other as the −X direction. The same is true for the Y and Z directions. The X direction corresponds to the first direction of the present invention. The Y direction corresponds to the second direction of the present invention.

The battery device 10 has four battery modules 12. The battery modules 12 are arranged in a row in the Y direction. Four battery modules 12 are connected in series.

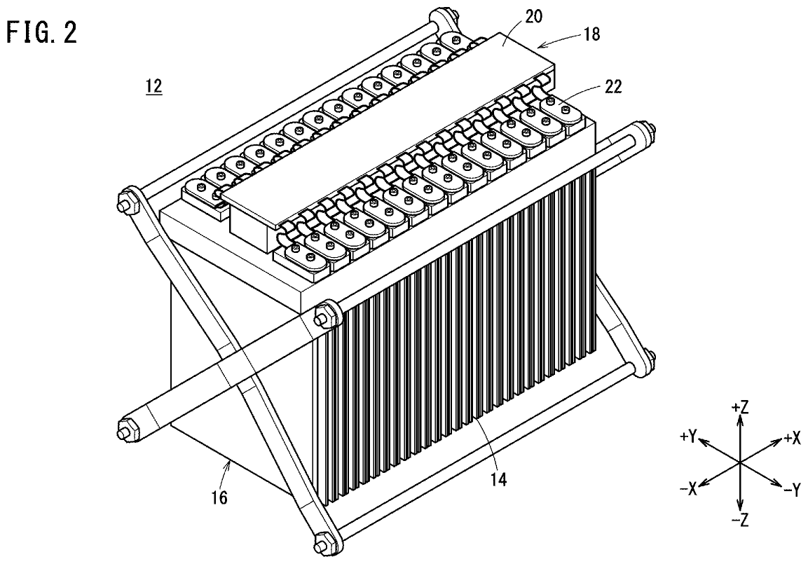

FIG. 2 is a perspective view of the battery module 12. The battery module 12 has a plurality of battery cells 14 stacked in the X direction. The stacked multiple battery cells 14 are connected in series. The stacked battery cells 14 are held by a battery frame 16. The battery frame 16 applies pressure to the stacked battery cells 14 by pressing the battery cells 14 from both ends. This suppresses the expansion of the battery cell 14.

The battery module 12 has a battery management device 18. The battery management device 18 monitors the cell voltage of each battery cell 14 and the temperature of the battery cell 14, and controls the charging and discharging of the battery module 12. The battery management device 18 has a main board 20 and a sub-board 22. The sub-board 22 is connected to four adjacent battery cells 14.

### Configuration of Battery Cells

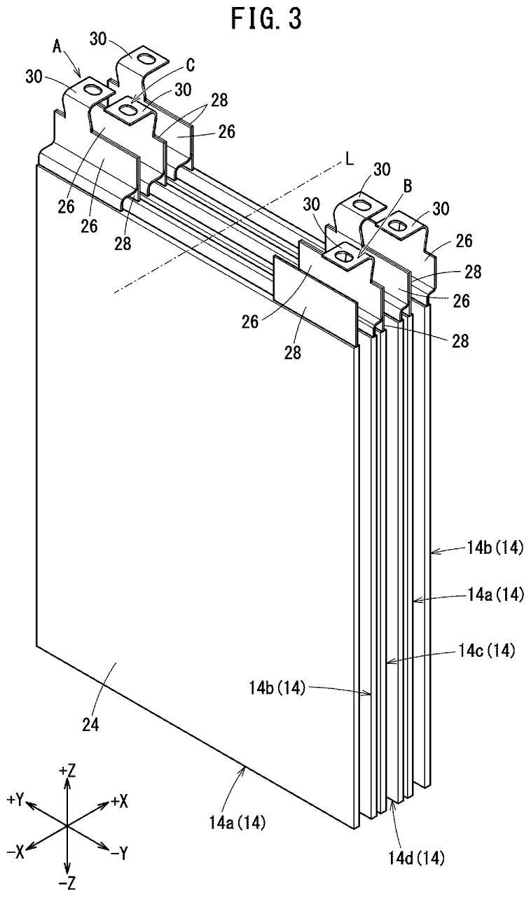

FIG. 3 is a perspective view of the battery cell 14. FIG. 3 shows a state where six battery cells 14 are stacked.

The battery cell 14 is a laminated-type battery. The battery cell 14 has a body portion 24 formed in a rectangular plate shape. The battery cell 14 has a positive electrode tab 26 and a negative electrode tab 28 formed in a plate shape. The positive electrode tab 26 and the negative electrode tab 28 project from the body portion 24 in the +Z direction. The positive electrode tab 26 is formed of aluminum, and the negative electrode tab 28 is formed of copper. The positive electrode tab 26 is formed integrally with a lead tab 30. A positive electrode tab 26 is located between the body portion 24 and the lead tab 30. There are four types of battery cells 14 differing in the shape of the lead tabs 30.

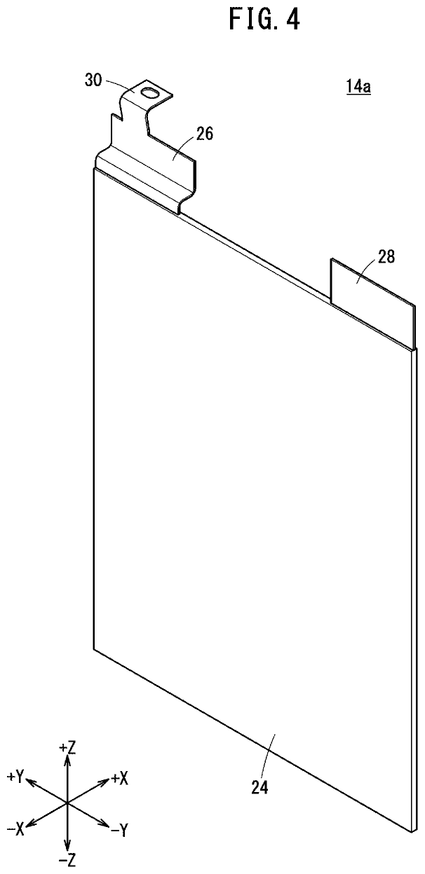

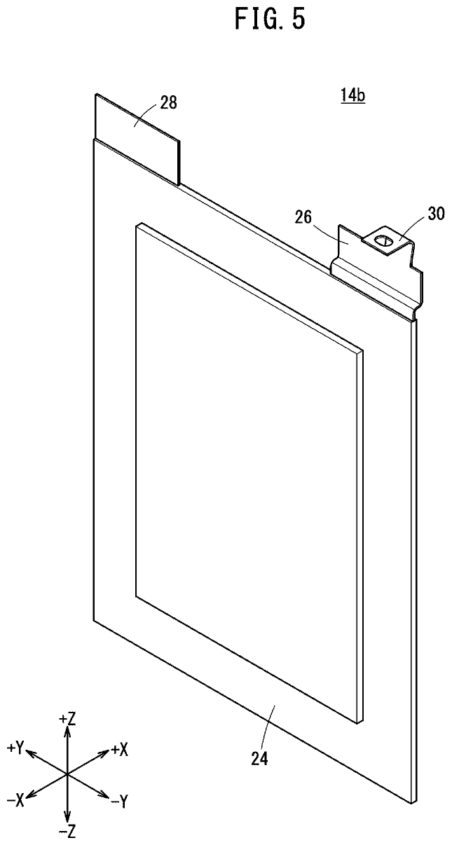

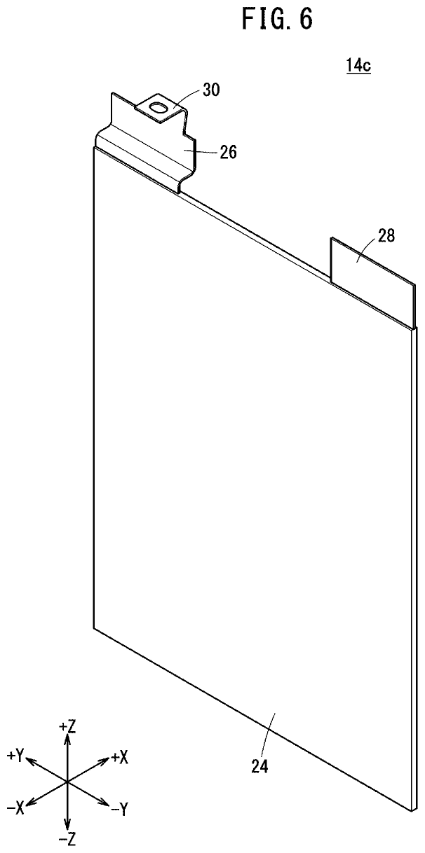

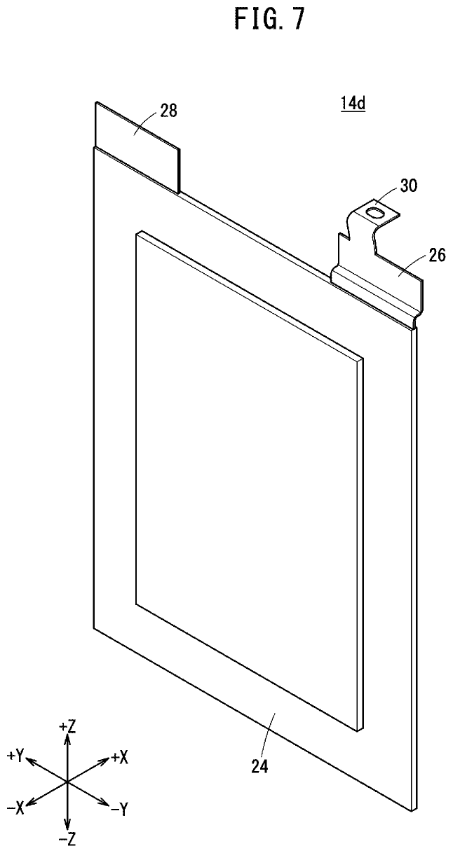

FIG. 4 is a perspective view showing a first battery cell 14a of the first type. FIG. 5 is a perspective view showing a second battery cell 14b of the second type. FIG. 6 is a perspective view showing a third battery cell 14c of the third type. FIG. 7 is a perspective view showing a fourth battery cell 14d of the fourth type.

As shown in FIGS. 4 and 5, the lead tabs 30 of the first battery cell 14a and the second battery cell 14b are located on an outer side in the width direction of the battery cell 14. On the other hand, as shown in FIGS. 6 and 7, the lead tabs 30 of the third battery cell 14c and the fourth battery cell 14d are located on an inner side in the width direction of the battery cell 14. As shown in FIGS. 4 and 7, the lead tabs 30 of the first battery cell 14a and the fourth battery cell 14d are bent in the +X direction. On the other hand, as shown in FIGS. 5 and 6, the lead tabs 30 of the second battery cell 14b and the third battery cell 14c are bent in the −X direction.

The positive electrode tab 26 of one battery cell 14 and the negative electrode tab 28 of another battery cell 14 adjacent to the one battery cell 14 are overlapped in the X direction and joined. Specifically, the positive electrode tab 26 of the first battery cell 14a and the negative electrode tab 28 of the second battery cell 14b are joined. The positive electrode tab 26 of the second battery cell 14b and the negative electrode tab 28 of the third battery cell 14c are joined. The positive electrode tab 26 of the third battery cell 14c and the negative electrode tab 28 of the fourth battery cell 14d are joined. The positive electrode tab 26 of the fourth battery cell 14d and the negative electrode tab 28 of the first battery cell 14a are joined. The joining of the positive electrode tab 26 and the negative electrode tab 28 is performed by, but not limited to, ultrasonic joining, welding, soldering, and the like. The positive electrode tab 26 and the negative electrode tab 28 may be fastened by bolts and nuts.

The positive electrode tab 26 of the first battery cell 14a corresponds to the first electrode tab of the present invention. The negative electrode tab 28 of the second battery cell 14b corresponds to the second electrode tab of the present invention. The positive electrode tab 26 of the third battery cell 14c corresponds to the third electrode tab of the present invention. The negative electrode tab 28 of the fourth battery cell 14d corresponds to the fourth electrode tab of the present invention.

As shown in FIG. 3, the lead tab 30 of the first battery cell 14a and the lead tab 30 of the third battery cell 14c are adjacent to each other in the Y direction. In addition, the lead tab 30 of the second battery cell 14b and the lead tab 30 of the fourth battery cell 14d are adjacent to each other in the Y direction. The lead tab 30 of the first battery cell 14a corresponds to the first lead tab of the present invention. The lead tab 30 of the third battery cell 14c corresponds to the second lead tab of the present invention.

As shown in FIG. 3, two rows of lead tabs 30 are arranged in the X direction on one side of the center line L. Two rows of lead tabs 30 are arranged in the X direction on the other side of the center line L. The center line L corresponds to a line connecting the centers in the width direction of the stacked battery cells 14.

### Connection between Battery Management Device and Lead Tab

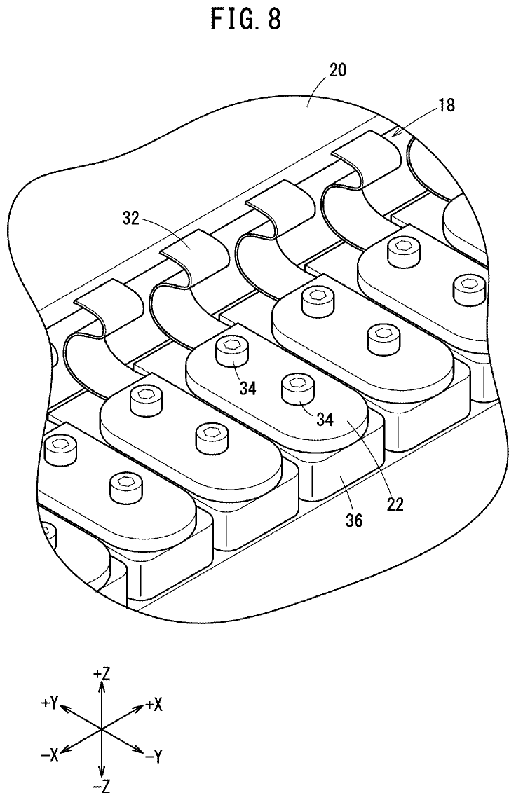

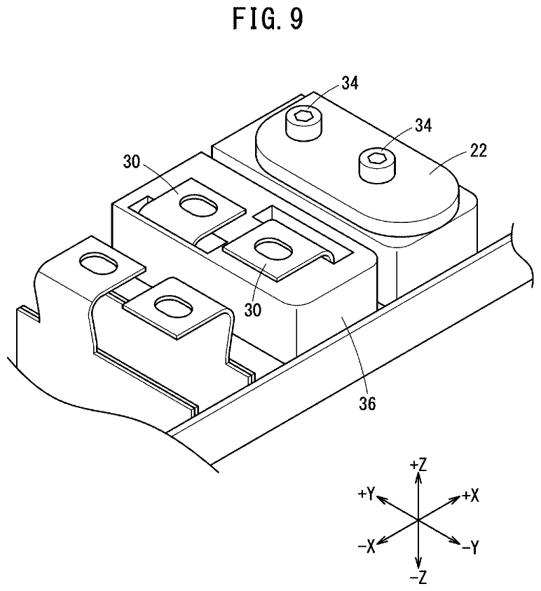

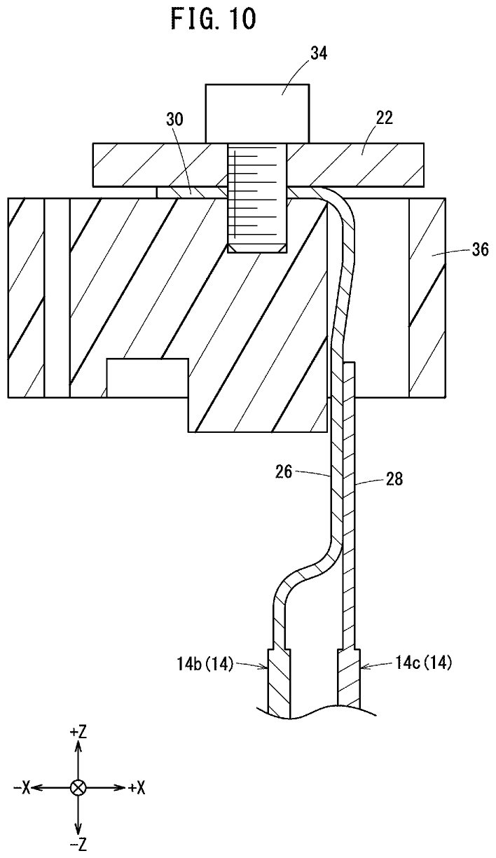

FIG. 8 is a perspective view of the battery module 12. FIG. 9 is a perspective view showing a connection portion between the sub-board 22 and the lead tab 30. FIG. 9 shows a state in which some of the sub-boards 22 and some of the terminal blocks 36 have been removed in order to make it easier to see the positional relationship between the lead tabs 30 and the terminal blocks 36. FIG. 10 is a cross-sectional view showing the connection portion between the sub-board 22 and the lead tab 30.

The sub-board 22 of the battery management device 18 is connected to the main board 20 via a flexible member 32. The flexible member 32 is provided with wiring for transmitting and receiving signals between the main board 20 and the sub-board 22.

Two lead tabs 30 adjacent to each other in the Y direction are connected to the sub-board 22. There is provided insulation between the two lead tabs 30 on the sub-board 22. The lead tab 30 together with the sub-board 22 are fixed to the terminal block 36 by bolts 34.

The battery management device 18 monitors the cell voltage of each battery cell 14 and the temperature of the battery cell 14, and controls the charging and discharging of the battery module 12. The battery management device 18 has the main board 20 and the sub-board 22. The sub-board 22 is connected to four adjacent battery cells 14. A temperature sensor chip (not shown) for acquiring the temperature of the battery cell 14 is mounted on the sub-board 22.

A computing device (not shown) for battery is mounted on the main board 20. The computing device for battery computes various information about the battery module 12 in addition to the cell voltage of each battery cell 14. For example, the computing device for battery computes the cell voltage of the second battery cell 14b based on the potential difference between the lead tab 30 of the first battery cell 14a indicated by arrow A in FIG. 3 and the lead tab 30 of the second battery cell 14b indicated by arrow B in FIG. 3. Further, the computing device for battery computes the cell voltage of the third battery cell 14c based on the potential difference between the lead tab 30 of the second battery cell 14b indicated by arrow B in FIG. 3 and the lead tab 30 of the third battery cell 14c indicated by arrow C in FIG. 3.

### Advantageous Effects

The battery device 10 of this embodiment has the lead tab 30 formed integrally with the positive electrode tab 26 provided for the first battery cell 14a, and the lead tab 30 formed integrally with the positive electrode tab 26 provided for the third battery cell 14c. The lead tab 30 of the first battery cell 14a is electrically connected to the positive electrode tab 26 provided for the first battery cell 14a and the negative electrode tab 28 provided for the second battery cell 14b. The lead tab 30 of the third battery cell 14c is electrically connected to the positive electrode tab 26 provided for the third battery cell 14c and the negative electrode tab 28 provided for the fourth battery cell 14d. Furthermore, the lead tab 30 of the first battery cell 14a and the lead tab 30 of the third battery cell 14c are adjacent to each other in the Y direction. In this way, a better battery device 10 can be provided.

In the case of the battery device 10 of this embodiment, two lead tabs 30 adjacent to each other in the Y direction are connected to one sub-board 22. Therefore, the number of sub-boards 22 can be about half of the number of battery cells 14, and the number of components can be reduced.

In the case of the battery device 10 of this embodiment, the lead tab 30 of the first battery cell 14a is bent in the +X direction, and the lead tab 30 of the third battery cell 14c is bent in the −X direction. Thus, the lead tab 30 of the first battery cell 14a and the lead tab 30 of the third battery cell 14c can overlap with each other in the Y-direction view in a middle portion between the first battery cell 14a and the third battery cell 14c.

In the case of the battery device 10 of this embodiment, the lead tab 30 of the second battery cell 14b is bent in the −X direction, and the lead tab 30 of the fourth battery cell 14d is bent in the +X direction. Thus, the lead tab 30 of the second battery cell 14b and the lead tab 30 of the fourth battery cell 14d can overlap with each other in the Y-direction view in a middle portion between the second battery cell 14b and the fourth battery cell 14d.

In the case of the battery device 10 of the present embodiment, the first battery cell 14a has the lead tab 30 formed integrally with the positive electrode tab 26, and the positive electrode tab 26 is located between the body portion 24 and the lead tab 30. Similarly, the second battery cell 14b has the lead tab 30 formed integrally with the positive electrode tab 26, and the positive electrode tab 26 is located between the body portion 24 and the lead tab 30. In addition, the third battery cell 14c has the lead tab 30 formed integrally with the positive electrode tab 26, and the positive electrode tab 26 is located between the body portion 24 and the lead tab 30. Furthermore, the fourth battery cell 14d has the lead tab 30 formed integrally with the positive electrode tab 26, and the positive electrode tab 26 is located between the body portion 24 and the lead tab 30.

Since multiple battery cells 14 are connected in series with each other, the positive electrode tab 26 of one battery cell 14 is connected to the negative electrode tab 28 of another battery cell 14 adjacent to the one battery cell 14. A relatively large electric current flows between the positive electrode tab 26 and the negative electrode tab 28, and the heat generated at the positive electrode tab 26 and the negative electrode tab 28 is large. On the other hand, because a relatively small electric current flows through the lead tab 30, the amount of heat generated at the lead tab 30 can be reduced.

In the case of the battery device 10 of this embodiment, the positive electrode tab 26 of the first battery cell 14a and the negative electrode tab 28 of the second battery cell 14b are overlapped in the X direction. Similarly, the positive electrode tab 26 of the second battery cell 14b and the negative electrode tab 28 of the third battery cell 14c are overlapped in the X direction. In addition, the positive electrode tab 26 of the third battery cell 14c and the negative electrode tab 28 of the fourth battery cell 14d are overlapped in the X direction. Furthermore, the positive electrode tab 26 of the fourth battery cell 14d and the negative electrode tab 28 of the first battery cell 14a are overlapped in the X direction. This allows a large contact area between the positive electrode tab 26 and the negative electrode tab 28.

If the positive electrode tab 26 and the negative electrode tab 28 of adjacent battery cells 14 are to be connected by bus bars, bus bars equal to or more than the number of battery cells 14 are required. In this embodiment, the positive electrode tab 26 and the negative electrode tab 28 of adjacent battery cells 14 are directly overlapped and connected, whereby the number of components can be reduced.

In the case of the battery device 10 of this embodiment, the sub-board 22 of the battery management device 18 is connected to the main board 20 via the flexible member 32. This allows relative movement of the sub-board 22 with respect to the main board 20. This allows the sub-board 22 to move in accordance with the position of the lead tab 30 of the battery cell 14.

### Inventions Obtained from Embodiment

The inventions that can be understood from the above embodiments are described below.

A battery device (10) comprising: a plurality of battery cells (14) stacked in a first direction; a first lead tab (30) that is electrically connected to a first electrode tab (26) provided for a first battery cell (14a) among the plurality of battery cells, and a second electrode tab (28) provided for a second battery cell (14b) adjacent to the first battery cell among the plurality of battery cells, and is formed integrally with at least one of the first electrode tab or the second electrode tab; and a second lead tab (30) that is electrically connected to a third electrode tab (26) provided for a third battery cell (14c) among the plurality of battery cells, and a fourth electrode tab (28) provided for a fourth battery cell (14d) adjacent to the third battery cell among the plurality of battery cells, and is formed integrally with at least one of the third electrode tab or the fourth electrode tab, wherein the first lead tab and the second lead tab are adjacent to each other in a second direction that intersects the first direction. In this way, a better battery device 10 can be provided.

For the battery device described above, the first lead tab may be bent toward one side in the first direction, and the second lead tab may be bent toward another side in the first direction. This allows the first lead tab and the second lead tab to, in a middle portion between the first battery cell and the third battery cell, overlap in the direction that intersects the first direction.

For the battery device above, the first battery cell may have a body portion (24) provided with the first electrode tab, the first lead tab is formed integrally with the first electrode tab, and the first electrode tab may be located between the body portion and the first lead tab. This can reduce the heat generation at the first lead tab.

For the battery device above, the first electrode tab and the second electrode tab may be overlapped in the first direction. This allows a large contact area between the first electrode tab and the second electrode tab.

The battery device above may further comprise a sub-board (22) to which the first lead tab and the second lead tab are connected, and a main board (20) to which the sub-board is connected via a flexible member (32). Thus, the sub-board can be moved according to the positions of the first lead tab and the second lead tab.

The present invention is not limited to the above disclosure, and various configurations can be employed without departing from the gist of the present invention.

The above embodiment has described, as an example, the case where two rows of lead tabs 30 extending in the X direction are arranged on one side of the center line L and two rows of lead tabs 30 extending in the X direction are arranged on the other side of the center line L, but the present invention is not limited to this example. Three or more rows of lead tabs 30 extending in the X direction may be arranged on one side of the center line L, and three or more rows of lead tabs 30 extending in the X direction may be arranged on the other side of the center line L.

As previously described, the positive electrode tab 26 is formed of aluminum and the negative electrode tab 28 is formed of copper. Since aluminum is softer than copper, when the lead tab 30 is formed integrally with the positive electrode tab 26 as in the above embodiment, it is easy to perform a bending process for the lead tab 30. However, the lead tab 30 may be formed integrally with the negative electrode tab 28. That is, the lead tab 30 may be provided only at the positive electrode tab 26, only at the negative electrode tab 28, or at both the positive electrode tab 26 and the negative electrode tab 28.

1. A battery device comprising:
a plurality of battery cells stacked in a first direction;
a first lead tab that is electrically connected to a first electrode tab provided for a first battery cell among the plurality of battery cells, and a second electrode tab provided for a second battery cell adjacent to the first battery cell among the plurality of battery cells, and is formed integrally with at least one of the first electrode tab or the second electrode tab; and
a second lead tab that is electrically connected to a third electrode tab provided for a third battery cell among the plurality of battery cells, and a fourth electrode tab provided for a fourth battery cell adjacent to the third battery cell among the plurality of battery cells, and is formed integrally with at least one of the third electrode tab or the fourth electrode tab,
wherein the first lead tab and the second lead tab are adjacent to each other in a second direction that intersects the first direction.

2. The battery device according to claim 1,
wherein
the first lead tab is bent toward one side in the first direction, and
the second lead tab is bent toward another side in the first direction.

3. The battery device according to claim 1,
wherein
the first battery cell includes a body portion provided with the first electrode tab,
the first lead tab is formed integrally with the first electrode tab, and
the first electrode tab is located between the body portion and the first lead tab.

4. The battery device of claim 3,
wherein the first electrode tab and the second electrode tab are overlapped in the first direction.

5. The battery device according to claim 1, further comprising:
a sub-board to which the first lead tab and the second lead tab are connected; and
a main board to which the sub-board is connected via a flexible member.
